(19) United States
(12) Patent Application Publication
(10) Pub. No.: US 2010/0015991 A1
(43) Pub. Date: Jan. 21, 2010

(54) SYSTEM AND METHOD FOR CALLING A GEOSOC

(75) Inventors: Gregory M. Evans, Raleigh, NC (US); Eugene M. Farrelly, Cary, NC (US)

Correspondence Address: WITHROW & TERRANOVA CT, 100 REGENCY FOREST DRIVE , SUITE 160, CARY, NC, 27518, US

(73) Assignee: Kota Enterprises, LLC, Wilmington, DE (US)

(21) Appl. No.: 12/173,224

(22) Filed: Jul. 15, 2008

(51) Int. Cl. H04Q 7/20

(52) U.S. Cl. 455/456.1

(57) ABSTRACT

A system and method are provided for facilitating communication between a first user and a second user that is in a social network of a user of interest to the first user and located at or near a location at which the user of interest is located or believed to be located. In general, the first user identifies a user of interest and a location at which the user of interest is located or is believed to be located. A number of other users that are in a social network of the user of interest and located in a geographic area of interest corresponding to the specified location or a geographic area about and including the specified location are identified. Communication is then facilitated between the first user and one or more of the identified users.

### FIELD OF THE INVENTION

The present invention relates to a location-based service for establishing communication between a first user and a second user at or near a location of a user of interest to the first user.

### BACKGROUND OF THE INVENTION

There are many circumstances in which a user would like to contact another user who is currently inaccessible. For example, the inaccessible user may have forgotten his or her mobile telephone, have his or her mobile telephone turned off, or not be answering his or her mobile telephone. As such, there is a need for a system and method that enables a user to reach an inaccessible user.

### SUMMARY OF THE INVENTION

The present invention relates to facilitating communication between a first user and a second user that is in a social network of a user of interest to the first user and located at or near a location at which the user of interest is located or believed to be located. This may be beneficial to, for example, relay a message to the user of interest if the user of interest has forgotten his or her mobile telephone, has turned off his or her mobile telephone, is not answering his or her mobile telephone, or the like. In general, the first user identifies a user of interest and a location at which the user of interest is located or is believed to be located. A number of other users that are in a social network of the user of interest and located in a geographic area of interest corresponding to the specified location or a geographic area about and including the specified location are identified. Communication is then facilitated between the first user and one or more of the identified users. The type of communication facilitated may be, for example, a voice session such as a mobile telephone call or a voice chat session, text-messaging such as a Short Messaging Service (SMS) text-messaging, or the like.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a system for facilitating communication between a first user and a second user that is in a social network of a user of interest to the first user and located at or near a location at which the user of interest is located or believed to be located according to one embodiment of the present invention;

FIG. 2 illustrates the operation of the system of FIG. 1 according to one embodiment of the present invention;

FIG. 3 illustrates an exemplary Graphical User Interface (GUI) enabling a user to identifying a user of interest, specify a location at which the user of interest is located or believed to be located, and select a desired social network group of the user of interest according to one embodiment of the present invention;

FIGS. 4 and 5 illustrate exemplary GUIs enabling a user with which communication has been initiated according to the process of FIG. 2 to accept or decline communication according to one embodiment of the present invention;

FIG. 6 is a block diagram of a server hosting the GeoSoc service of FIG. 1 according to one embodiment of the present invention; and

FIG. 7 is a block diagram of one of the mobile devices of FIG. 1 according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

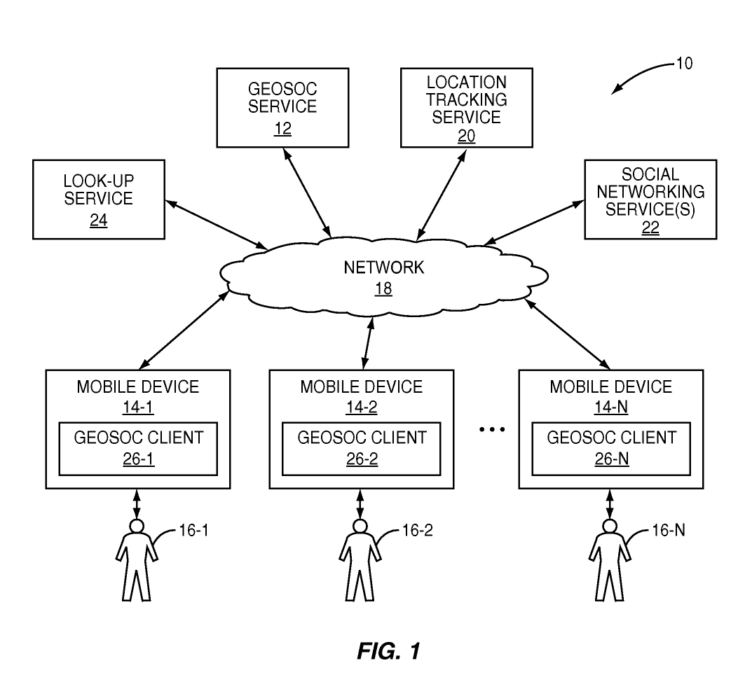

FIG. 1 illustrates a system 10 for facilitating communication between a first user and a second user that is in a social network of a user of interest to the first user and located at or near a location at which the user of interest is located or believed to be located according to one embodiment of the present invention. In general, the system 10 includes a GeoSoc (pronounced gee-oh-soh-sh) service 12 and a number of mobile devices 14-1 through 14-N having associated users 16-1 through 16-N. The GeoSoc service 12 and the mobile devices 14-1 through 14-N are connected via a network 18. The network 18 may be any type of Wide Area Network (WAN) or Local Area Network (LAN), or any combination thereof. In addition, the network 18 may include wired components, wireless components, or both wired and wireless components. For example, the network 18 may be the Internet; a cellular telephone or data network such as a 2G, 3G, or emerging 4G network including mobile WiMAX and Long Term Evolution (LTE) networks; or the like. As discussed below, communication, such as voice communication, is established between users. This communication may be established using a single communication service or a combination of communication services such as traditional cellular telecommunications services, Voice over Internet Protocol (VoIP), or other public or proprietary communication services.

In addition, the system 10 includes a location tracking service 20. The location tracking service 20 generally operates to track, and optionally validate, locations of the users 16-1 through 16-N. In one embodiment, the location tracking service 20 tracks the locations of the users 16-1 through 16-N by tracking the locations of the mobile devices 14-1 through 14-N. The locations of the mobile devices 14-1 through 14-N may be determined using, for example, Global Positioning System (GPS) receivers implemented within or associated with the mobile devices 14-1 through 14-N, triangulation such as mobile base station triangulation, or the like, or any combination thereof. In addition, the location tracking service 20 may validate the locations of the users 16-1 through 16-N. For example, the mobile devices 14-1 through 14-N may determine their locations using GPS receivers and report their locations, automatically or upon request, to the location tracking service 20 as the locations of the corresponding users 16-1 through 16-N. The location tracking service 20 may then validate the reported locations using locations of the mobile devices 14-1 through 14-N determined by another means such as triangulation. In addition or alternatively, the reported locations may be validated using historical records of the locations of the users 16-1 through 16-N.

Still further, the system 10 includes a social networking service 22. Note that while only one social network service 22 is illustrated and discussed for clarity and ease of discussion, the system 10 may include any number of one or more social networking services 22. The social networking service 22 may be, for example, a social networking website such as MySpace, FaceBook, LinkedIN, or the like. As another example, the social networking service 22 may be a social networking service provided by one or more mobile telecommunications service providers providing mobile telecommunications service to the mobile devices 14-1 through 14-N. As yet another example, traditional family locator services, such as the Sprint Family Locator service or the Verizon Chaperone service, provided by one or more mobile telecommunications service providers may be used where hierarchical links are defined between different family plans to form the social network. Regardless of the implementation, the social networking service 22 maintains information defining a social network of each of the users 16-1 through 16-N. Further, the social networks of the users 16-1 through 16-N may be divided into a number of social network groups. Using the user 16-1 as an example, the social network of the user 16-1 may include a “friends” social network group, a “family” social network group, a “co-worker” social network group, a “baseball team” social network group, a “church” social network group, or the like. Lastly, the system 10 may include a look-up service 24. The look-up service 24 may be used to determine or validate mobile telephone numbers of the mobile devices 14-1 through 14-N. Note that as used herein, the social network of a user includes other users having a direct relationship with the user and may optionally further include other users having indirect relationships (e.g., friend-of-a-friend relationships) with the user.

The mobile devices 14-1 through 14-N may be, for example, mobile smart phones such as Apple® iPhones or the like. However, the present invention is not limited thereto. The mobile devices 14-1 through 14-N include GeoSoc clients 26-1 through 26-N, respectively. The GeoSoc clients 26-1 through 26-N are preferably implemented in software. However, the present invention is not limited thereto. The GeoSoc clients 26-1 through 26-N may be implemented in software, hardware, or a combination thereof.

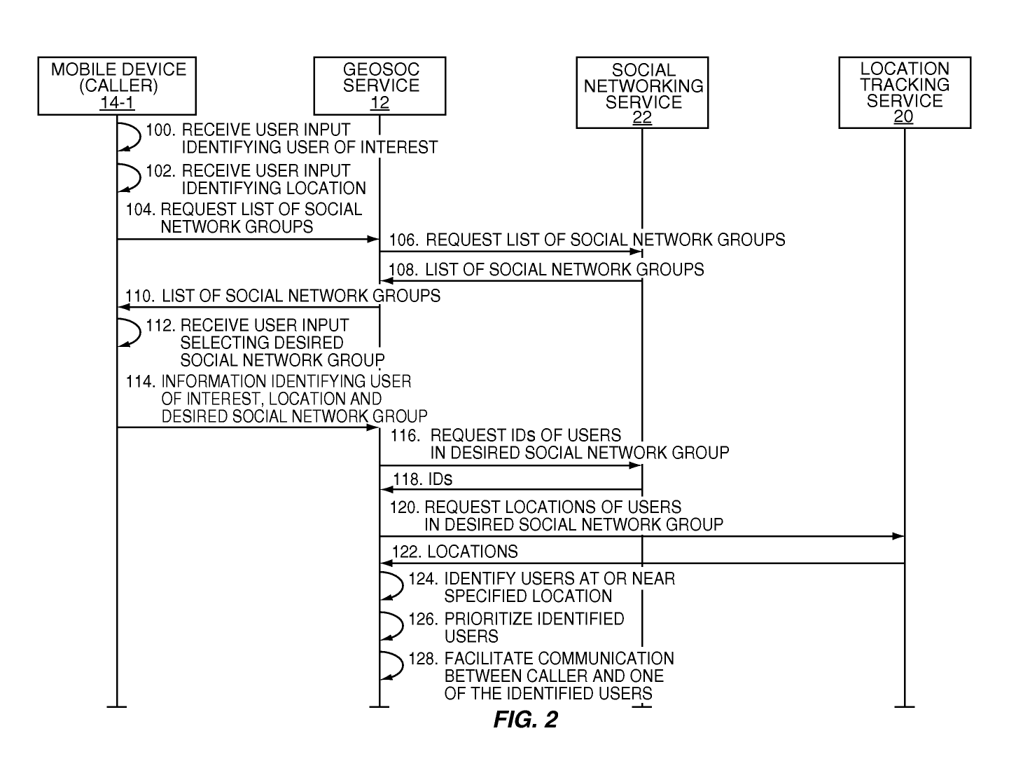

FIG. 2 illustrates the operation of the system 10 of FIG. 1 according to one embodiment of the present invention. First, the GeoSoc client 26-1 of the mobile device 14-1 receives user input from the user 16-1 identifying a user of interest (step 100). The information identifying the user of interest may be, for example, a mobile telephone number of the user of interest, a name of the user of interest, or both the mobile telephone number and name of the user of interest. However, the present invention is not limited thereto. For example, the information identifying the user of interest alternatively may be a user identifier of the user of interest such as a username or user ID used by the user of interest with respect to the social networking service 22 or the like. In addition, the GeoSoc client 26-1 of the mobile device 14-1 receives user input from the user 16-1 identifying a location at which the user of interest is known to be located or at which the user of interest is believed to be located (step 102). For example, the GeoSoc client 26-1 may enable the user 16-1 to enter a street address, geographic coordinates, or the like for a location at which the user 16-1 knows or believes the user of interest is located. Rather than entering manually entering the location, the GeoSoc client 26-1 may enable the user 16-1 to select the location from a map, a series of one or more pull-down menus, or the like.

In this example, the GeoSoc client 26-1 of the mobile device 14-1 sends a request for a list of social network groups of the user of interest to the GeoSoc service 12 (step 104). Note that if the GeoSoc client 26-1 has previously requested and cached the list of social network groups for the user of interest, the GeoSoc client 26-1 may use the previous list of social network groups for the user of interest. However, if the previous list has timed-out, the GeoSoc client 26-1 may request a new list or an update to the previous list of social network groups of the user of interest from the GeoSoc client 12. The previous list may time-out after a defined amount of time, after the GeoSoc client 26-1 has been notified or otherwise determines that there has been a change to the list of social network groups of the user of interest, or the like.

Using the information identifying the user of interest, the GeoSoc service 12 queries the social networking service 22 for a list of one or more social network groups of the user of interest (step 106). Note that if the GeoSoc service 12 has previously requested and obtained a list of one or more social network groups for the user of interest from the social networking service 22, the GeoSoc service 12 may not make the request of the social network service 22. However, the GeoSoc service 12 may still request the list of social network groups of the user of interest from the social networking service 22 if the previously obtained list has timed-out. A previous list may time-out after a predetermined amount of time, after the GeoSoc service 12 has been notified or otherwise determines that there has been a change to the list of social network groups of the user of interest, or the like.

In response to a request from the GeoSoc service 12 for a list of social network groups of the user of interest, the social networking service 22 returns a list of social network groups of the user of interest to the GeoSoc service 12 (step 108), and the GeoSoc service 12 returns the list of social network groups of the user of interest to the GeoSoc client 26-1 of the mobile device 14-1 of the user 16-1 (step 110). The GeoSoc client 26-1 of the mobile device 14-1 then enables the user 16-1 to select a desired social network group from the list of social network groups of the user of interest (step 112). For example, if the list of social network groups includes an entry for a “friends” social network group, an entry for a “family” social network group, and an entry for a “co-worker” social network group, the user 16-1 may select the “friends” social network group as the desired social network group. The GeoSoc client 26-1 of the mobile device 14-1 then sends the information identifying the user of interest, information identifying the location specified by the user 16-1, and information identifying the desired social network group selected by the user 16-1 to the GeoSoc service 12 (step 114).

The GeoSoc service 12 then requests information identifying users in the desired social group of the user of interest from the social networking service 22 (step 116). In response, the social networking service 22 returns information identifying the users in the desired social network group of the user of interest (step 118). The information identifying the users may be, for example, mobile telephone numbers of the users, names of the users, or the like. Note that for most of the discussion herein, the users in the desired social network group of the user of interest are other users from the users 16-2 through 16-N of the mobile devices 14-2 through 14-N, which include GeoSoc clients 26-2 through 26-N. However, the present invention is not limited thereto. For example, the users in the desired social network group of the user of interest may additionally or alternatively include users of location-aware mobile devices that are not equipped with GeoSoc clients such as, but not limited to, a GPS enabled mobile telephone

In an alternative embodiment, social network groups may not be defined or utilized. As such, steps 104-114 may be skipped, and the GeoSoc service 12 may then request and receive information identifying all users in the social network of the user of interest or all users in the social network of the user of interest satisfying one or more criteria defined by the user 16-1. These one or more criteria may generally be any type of criteria based on information contained in user profiles maintained by the social networking service 22 for the users in the social network of the user of interest. For example, these one or more criteria may be a maximum degree of separation from the user of interest in the social network, a desired age or age range, a desired gender, or the like.

While not illustrated, the GeoSoc service 12 may utilize the look-up service 24 in order to validate or obtain the mobile telephone numbers of the users in the desired social network group of the user of interest. The GeoSoc service 12 then requests the locations of the users in the desired social network group of the user of interest from the location tracking service 20 (step 120). In one embodiment, the location tracking service 20 maintains the locations of the users 16-1 through 16-N and utilizes the mobile telephone numbers of the corresponding mobile devices 14-1 through 14-N as identifiers of the users 16-1 through 16-N. As such, when requesting the locations, the GeoSoc service 12 may provide the mobile telephone numbers of the users in the desired social network group of the user of interest to the location tracking service 20. The location tracking service 20 then returns the locations of the users in the desired social network group of the user of interest to the GeoSoc service 12 (step 122).

In this example, the GeoSoc service 12 then identifies users from the desired social network group of the user of interest that are at or near the location specified by the user 16-1 (step 124). More specifically, in one embodiment, the GeoSoc service 12 identifies users from the desired social network group that are located within a geographic area of interest. The geographic area of interest corresponds to either the specified location or a geographic area about and including the specified location. The geographic area about and including the specified location may be defined by a maximum distance from the specified location, a maximum driving or traveling time from the specified location, or the like. The GeoSoc service 12 may then prioritize the identified users that are in the desired social network group of the user of interest and located at or near the specified location (step 126). The identified users may be prioritized based on any one or more suitable criteria. Preferably, the criteria are indicative of strength of relationship between the identified users and the user of interest. However, the present invention is not limited thereto. For example, the identified users may be prioritized based on a number of calls between the identified users and the user of interest. The number of calls between the identified users and the user of interest may be determined from, for example, corresponding call logs obtained from the mobile devices of the identified users.

The GeoSoc service 12 then facilitates communication between the user 16-1 and one or more of the identified users (step 128). In one embodiment, the GeoSoc service 12 facilitates a phone call between the user 16-1 and one of the identified users. More specifically, the GeoSoc service 12 first initiates a phone call with the identified user having a highest priority. As an example, assume that the identified user having the highest priority is the user 16-2. As such, the GeoSoc service 12 may first notify the GeoSoc client 26-2 that the user 16-1 desires to establish communication with the user 16-2 regarding the user of interest. In one embodiment, the user 16-2 may have pre-defined desired courses of action to take with respect to a number of other users including the user of interest. The desired course of action may be to automatically accept the call, automatically decline the call, or notify the user 16-2 to enable the user 16-2 to decide whether to accept the call or decline the call. Note that where the user 16-2 is notified, the GeoSoc client 26-2 may enable the user 16-2 to verify the user 16-1 before deciding whether to accept or decline the call. The user 16-1 may be verified based on information previously defined by the user of interest. For example, the user of interest may pre-define a number of users for which he or she recommends accepting calls, a number of users for which he or she recommends declining calls, or both. In another embodiment, desired courses of action may not be defined, and the GeoSoc client 26-2 may notify the user 16-2 to enable the user 16-2 to accept the call or decline the call. Again, in this embodiment, the user 16-2 may be enabled to verify the user 16-1 before deciding whether to accept or decline the call.

In alternative embodiment, if the mobile device 14-2 of the user 16-2 were not equipped with the GeoSoc client 26-2, the user 16-2 may be prompted of the initiation of the call by a third party real or automated operator such as that traditionally used for collect calls, notified of the initiation of the call by a text message provided prior to receiving the call with a message as to why the call is being initiated, or the like. Still further, a customized caller ID may be utilized to notify the user 16-2 of the initiation of the call and the fact that the call is being initiated by a user of the GeoSoc service 12.

If the user 16-2 accepts the call, the GeoSoc service 12 facilitates the call between the mobile device 14-1 of the user 16-1 and the mobile device 14-2 of the user 16-2. For example, the GeoSoc service 12 may establish a first call with the mobile device 14-1 of the user 16-1, establish a second call with the mobile device 14-2 of the user 16-2, and then connect the two calls to provide a resulting call between the mobile devices 14-1 and 14-2 of the users 16-1 and 16-2. Note that in this process, the contact information for the user 16-2 may be hidden from the user 16-1. Also, note that the information identifying the users from the desired social network group of the user of interest that are located at or near the specified location may also be hidden from the user 16-1. If the user 16-2 denies the call, the GeoSoc service 12 continues to initiate calls with the remaining identified users in order according to their priorities until a call is established between the user 16-1 and one of the identified users or the last identified user has been processed. If the GeoSoc service 12 is unable to facilitate a call between the user 16-1 and one of the identified users, the GeoSoc service 12 may return an error message to the GeoSoc client 26-1 of the mobile device 14-1 of the user 16-1 or continue to process the list of identified users until a call has been established or the process has been terminated by the user 16-1.

Note that while the example above uses a phone call to establish communication between the user 16-1 and one of the identified users, the present invention is not limited thereto. Communication may be established using any desired type of communication session. For example, communication may alternatively be established via text-messaging such as SMS text-messaging, a voice-based or text-based chat session, or the like. Still further, rather than facilitating two-way communication, the GeoSoc service 12 may facilitate one-way communication from the user 16-1 to one or more of the identified users. For example, the user 16-1 may record a voice message or enter a text message. The GeoSoc service 12 may then provide the recorded voice message or text message to mobile devices of one or more of the identified users. The contact information of the user 16-1 may be included in the message or automatically attached to the message so that the one or more identified users may respond to the user 16-1 if desired. Also note that while the discussion above focuses on the mobile devices 14-1 through 14-N, the present invention is equally applicable to other types of communication devices such as personal computers or the like. For example, the calling user 16-1 and/or one or more of the identified users may be associated with stationary communication devices incorporating GeoSoc clients rather than mobile devices as discussed above. The location of a stationary communication device may be input by the corresponding user, determined based on information such as an IP address of the stationary device, obtained from a GPS receiver within or associated with the stationary device, or the like.

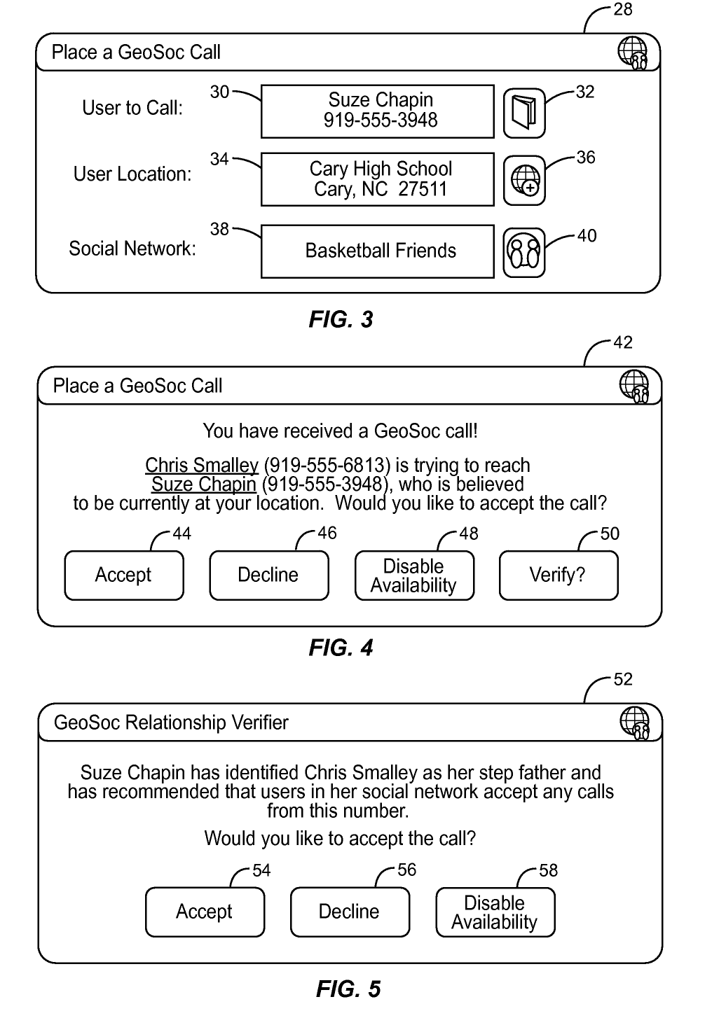

Continuing the example given above with respect to FIG. 2, FIG. 3 illustrates an exemplary Graphical User Interface (GUI) 28 presented to the user 16-1 by the GeoSoc client 26-1 in order to enable the user 16-1 to identify the user of interest, identify the location at which the user of interest is located or believed to be located, and select a desired social network group of the user of interest according to an exemplary embodiment of the present invention. More specifically, a user field 30 includes information identifying the user of interest, which in this example is the name and telephone number of the user of interest. An address book button 32 may be activated by the user 16-1 in order to access an address book of the user 16-1 maintained by, for example, the mobile device 14-1 and select the user of interest from the address book. Otherwise, the user 16-1 may manually enter the information identifying the user of interest into the user field 30.

A location field 34 includes information identifying a location at which the user 16-1 knows the user of interest to be located or believes the user of interest to be located. A location button 36 may be activated by the user 16-1 in order to, for example, activate a map from which the user 16-1 may select the location for the location field 34. Otherwise, the user 16-1 may manually enter the location into the location field 34. Lastly, a social network field 38 may include information identifying a desired social network group, or a desired social network, of the user of interest. A social network button 40 may be activated by the user 16-1 in order to view the list of social network groups of the user of interest and select one or more desired social network groups from the list. In addition or alternatively, the user 16-1 may be enabled to select one or more social networks (e.g., MySpace, Friendster, LinkedIN, Yahoo! Instant Messenger contact list, etc.) of the user of interest.

FIG. 4 illustrates a GUI 42 presented to a user, such as the user 16-2, when the GeoSoc service 12 initiates communication between the calling or initiating user 16-1 and the user 16-2 according to one embodiment of the present invention. As illustrated, the GUI 42 notifies the user 16-2 that the user 16-1, which in this example is Chris Smalley, is trying to reach the user of interest, which in this example is Suze Chapin. The GUI 42 includes an accept button 44, a decline button 46, a disable availability button 48, and a verify button 50. If the user 16-1 activates the accept button 44, the GeoSoc client 26-2 notifies the GeoSoc service 12, which, in response, facilitates or establishes communication between the user 16-1 and the user 16-2. If the user 16-2 activates the decline button 46, the GeoSoc client 26-2 notifies the GeoSoc service 12, which, in response, proceeds to initiate communication with the next identified user. If the user 16-2 activates the disable availability button 48, the GeoSoc client 26-2 notifies the GeoSoc service 12 that the user 16-2 is no longer available for GeoSoc requests. As such, the GeoSoc service 12 removes the user 16-2 from the list of identified users and proceeds to initiate communication with the next identified user.

Lastly, if the user 16-2 activates the verify button 50, the GeoSoc client 26-2 verifies the user 16-1. For example, the GeoSoc client 26-2 may request verification from the GeoSoc service 12. The GeoSoc service 12 may then determine whether the user of interest has previously indicated that the identified users should accept or decline communication from the user 16-1 when the user 16-1 is trying to reach the user of interest. The GeoSoc service 12 then sends a response to the GeoSoc client 26-2 verifying the user 16-1 if the user of interest has recommended accepting communication from the user 16-1 or not verifying the user 16-1 if the user of interest has recommended declining communication from the user 16-1.

FIG. 5 illustrates a GUI 52 provided by the GeoSoc client 26-2 of the user 16-2 in response to activation of the verify button 50 of FIG. 4 according to one embodiment of the present invention. As illustrated, the GUI 52 includes a message verifying the user 16-1. Based on the verification, the user 16-2 may then choose to accept the communication by activating an accept button 54, decline the communication by activating a decline button 56, or disable availability by activating a disable availability button 58.

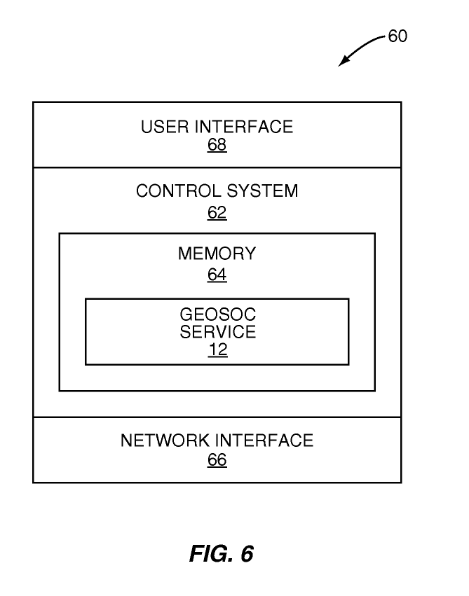

FIG. 6 is a block diagram of a server 60 hosting the GeoSoc service 12 of FIG. 1 according to one embodiment of the present invention. In general, the server 60 includes a control system 62 having associated memory 64. In this example, the GeoSoc service 12 is implemented in software and stored in the memory 64. However, the present invention is not limited thereto. The GeoSoc service 12 may be implemented in software, hardware, or a combination thereof. The server 60 also includes a network interface 66 communicatively coupling the server 60 to the network 18 (FIG. 1). The server 60 may also include a user interface 68, which may include components such as, for example, a display, one or more user input devices, or the like.

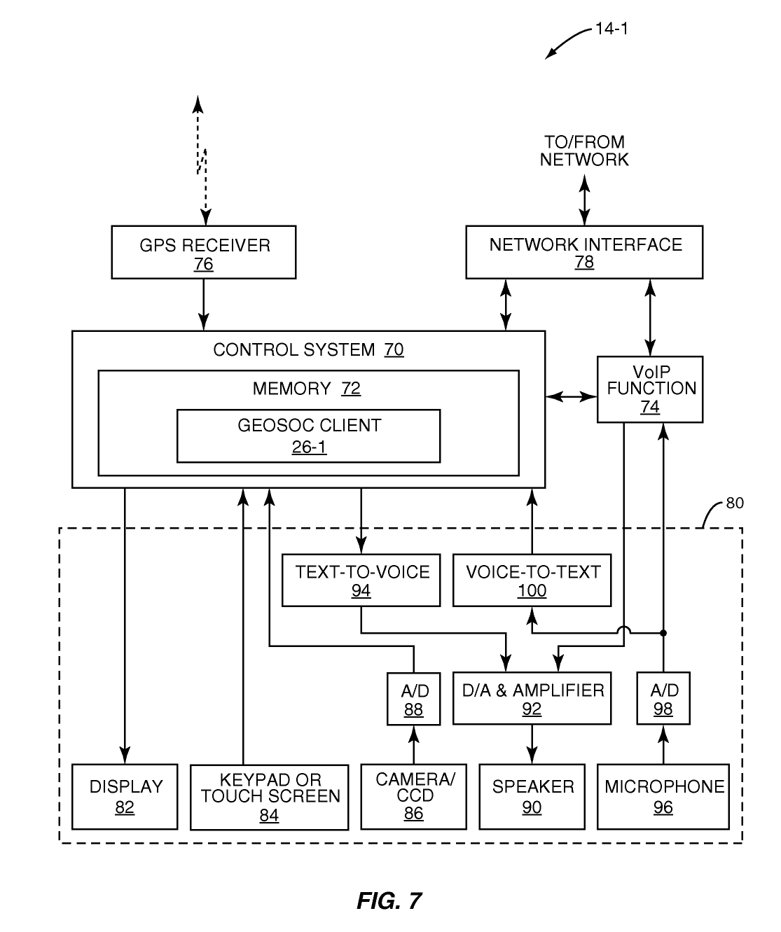

FIG. 7 is a block diagram of the mobile device 14-1 of FIG. 1 according to one embodiment of the present invention. This discussion is equally applicable to the other mobile devices 14-2 through 14-N. In general, the mobile device 14-1 includes a control system 70 having associated memory 72. In this example, the GeoSoc client 26-1 is implemented in software and stored in the memory 72. However, the present invention is not limited thereto. The GeoSoc client 26-1 may be implemented in software, hardware, or a combination thereof. In addition, the mobile device 14-1 includes a Voice Over Internet Protocol (VoIP) function 74 providing voice communication. In this example, the mobile device 14-1 also includes a GPS receiver 76 for determining a location of the mobile device 14-1 and thus the location of the user 16-1. Both the control system 70 and the VoIP function 74 are connected to the network 18 via a network interface 78. Lastly, the mobile device 14-1 includes a user interface 80. In this example, the user interface 80 includes a display 82 and a keypad or touch screen 84 connected to the control system 70. In addition, the user interface 80 may include a camera or Charge Coupled Device (CCD) sensor 86 connected to the control system 70 via an analog-to-digital (A/D) converter 88. The user interface 80 also includes a speaker 90 connected to the control system 70 via a digital-to-analog (D/A) converter and amplifier circuit 92 and a text-to-voice converter 94. The speaker 90 is also connected to the VoIP function 74 via the D/A converter and amplifier circuit 92. The user interface 80 also includes a microphone 96 connected to the control system 70 via an A/D converter 98 and a voice-to-text converter 100. The microphone 96 is also connected to the VoIP function 74 via the A/D converter 98.

It should be noted that the system 10 of FIG. 1 and the process of FIG. 2 provide substantial opportunity for variation without departing from the spirit or scope of the present invention. For example, in an alternative embodiment, the functionality of the GeoSoc service 12 may be incorporated into the GeoSoc clients 26-1 through 26-N. Thus, returning to the example above, the GeoSoc client 26-1 may interact directly with the location tracking service 20, the social networking service 22, and the optional look-up service 24 in order to facilitate communication with one or more users in the social network of the user of interest located at or near the location at which the user of interest is located or believed to be located. In this embodiment, the GeoSoc client 26-1 may be implemented as a protected application in order to hide the contact information of the contacted user and/or information identifying the users from the social network of the user of interest at or near the location at which the user of interest is located or believed to be located. Once communication is established, the contact information of the contacted user may be revealed.

As another example, while the GeoSoc service 12, the location tracking service 20, the social networking service 22, and the look-up service 24 are illustrated and discussed as being separate, the present invention is not limited thereto. Two or more of the GeoSoc service 12, the location tracking service 20, the social networking service 22, and the look-up service 24 may be implemented as a single function or application. For example, the GeoSoc service 12 or the social networking service 22 may incorporate the location tracking function 22.

Those skilled in the art will recognize improvements and modifications to the preferred embodiments of the present invention. All such improvements and modifications are considered within the scope of the concepts disclosed herein and the claims that follow.

What is claimed is:

1. A method comprising:
receiving information identifying a user of interest to a first user and information identifying a location;
identifying one or more users that are in a social network of the user of interest and located within a geographic area of interest associated with the location; and
facilitating communication between the first user and a second user from the one or more users that are in the social network of the user of interest and located within the geographic area of interest.

2. The method of claim 1 wherein the geographic area of interest corresponds to one of a group consisting of: the location and a defined area about and including the location.

3. The method of claim 1 wherein the location is one of a group consisting of: a location at which the user of interest is known to be located and a location at which the user of interest is believed to be located.

4. The method of claim 1 wherein identifying the one or more users that are in the social network of the user of interest and located within the geographic area of interest comprises:
obtaining information identifying a plurality of users in the social network of the user of interest;
obtaining a location of each of the plurality of users;
identifying one or more users from the plurality of users that are located within the geographic area of interest as the one or more users that are in the social network of the user of interest and located within the geographic area of interest.

5. The method of claim 4 wherein obtaining the information identifying the plurality of users in the social network of the user of interest comprises querying a social networking service to obtain the information identifying the plurality of users in the social network of the user of interest.

6. The method of claim 4 wherein obtaining the location of each of the plurality of users in the social network of the user of interest comprises querying a location tracking service to obtain the location of each of the plurality of users.

7. The method of claim 1 wherein a remote service hosts information identifying the social network of the user of interest and locations of users in the social network of the user of interest, and identifying the one or more users that are in the social network of the user of interest and are located within the geographic area of interest comprises querying the remote service to obtain information identifying the one or more users that are in the social network of the user of interest and located within the geographic area of interest.

8. The method of claim 1 wherein one or more social network groups are defined for the social network of the user of interest, and identifying the one or more users that are in the social network of the user of interest and located within the geographic area of interest comprises:
receiving information identifying a desired social network group from the one or more social network groups defined for the social network of the user of interest; and
identifying one or more users in the desired social network group that are located within the geographic area of interest as the one or more users that are in the social network of the user of interest and located within the geographic area of interest.

9. The method of claim 1 wherein facilitating communication between the first user and the second user comprises:
prioritizing the one or more users that are in the social network of the user of interest and located within the geographic area of interest;
processing the one or more users according to priority to identify a user from the one or more users that has expressed a willingness to accept communication from the first user as the second user; and
establishing communication between the first user and the second user.

10. The method of claim 1 wherein facilitating communication between the first user and the second user comprises facilitating a phone call between the first user and the second user.

11. The method of claim 10 wherein the phone call is a phone call to a mobile telecommunications device of the second user.

12. The method of claim 1 wherein facilitating communication between the first user and the second user comprises facilitating text-messaging between the first user and the second user.

13. The method of claim 1 wherein facilitating communication between the first user and the second user comprises facilitating delivery of a recorded voice message of the first user to a mobile device of the second user.

14. The method of claim 1 wherein facilitating communication between the first user and the second user comprises facilitating delivery of a pre-defined text message from the first user to a mobile device of the second user.

15. The method of claim 1 wherein facilitating communication between the first user and the second user comprises facilitating two-way communication between the first user and the second user.

16. The method of claim 1 wherein facilitating communication between the first user and the second user comprises facilitating one-way communication from the first user to the second user.

17. The method of claim 1 wherein the information identifying the user of interest is at least one of a group consisting of: a name of the user of interest, a mobile telephone number of the user of interest, and a social network identifier of the user of interest.

18. The method of claim 1 wherein the information identifying the location is at least one of a group consisting of: a street address and geographic coordinates.

19. The method of claim 1 wherein the method is a method of operation of a central service.

20. The method of claim 1 wherein the method is a method of operation of a communication device of the first user.

21. The method of claim 20 wherein the communication device of the first user is a mobile device.

22. The method of claim 1 wherein contact information for the second user is hidden from the first user.

23. The method of claim 1 wherein information identifying the one or more users that are in the social network of the user of interest and located within the geographic area of interest is hidden from the first user.

24. A central server comprising:
a network interface communicatively coupling the central server to a plurality of communication devices via a network; and
a control system associated with the network interface and adapted to:
receive information identifying a user of interest to a first user and information identifying a location;
identify one or more users that are in a social network of the user of interest and located within a geographic area of interest associated with the location; and
facilitate communication between the first user and a second user from the one or more users that are in the social network of the user of interest and located within the geographic area of interest via corresponding ones of the plurality of communication devices.

25. A computer readable medium comprising software for instructing a computing device to:
receive information identifying a user of interest to a first user and information identifying a location;
identify one or more users that are in a social network of the user of interest and located within a geographic area of interest associated with the location; and
facilitate communication between the first user and a second user from the one or more users that are in the social network of the user of interest and located within the geographic area of interest.
